(19) United States
(12) Patent Application Publication
(10) Pub. No.: US 2014/0282389 A1
(43) Pub. Date: Sep. 18, 2014

(54) HARDWARE ABSTRACTION LAYER SYSTEMS AND METHODS

(71) Applicant: LSI Industries, Inc., Cincinnati, OH (US)

(72) Inventor: Anton S. Yemelyanov, Montreal (CA)

(21) Appl. No.: 13/833,111

(22) Filed: Mar. 15, 2013

(51) Int. Cl. G06F 9/44

(52) U.S. Cl. CPC G06F 8/315
USPC 717/115; 717/116

(57) ABSTRACT

Systems and methods for interfacing with hardware components using object oriented programming are disclosed. In some examples, system includes processing hardware unit. System includes multiple first level hardware components, each first level hardware component being coupled with processing hardware unit. System includes multiple second level hardware components, each second level hardware component being coupled with at least one first level hardware component. System includes memory, accessible to processing hardware unit. Memory includes compiler for object oriented programming language. Memory includes first and multiple second objects in object oriented programming language. Each of first or second objects mirrors first or second level hardware component, respectively. Each of first or second objects includes representation of feature or functionality of first or second level hardware component and code for communicating with first or second level hardware component.

### BACKGROUND

The subject technology generally relates to hardware interfaces and, in particular, relates to interfacing with hardware components using object oriented programming.

Many complex systems utilize some form of control that is facilitated by software programs. Examples of systems including hardware structures controlled by software include, for example, large light emitting diode (LED) display systems (e.g., LED display board(s) at a stadium or on an outside wall of a building), lighting systems in a municipality, cars, airplanes, audio systems (e.g., at a nightclub or concert hall), etc. Oftentimes, these hardware structures and the associated controlling software are complex, and require much time and effort, possibly by skilled persons whose time is expensive, to repair, maintain, or diagnose problems.

For example, if a new component (e.g., a new LED screen in a LED display including multiple screens) were added to the LED display system, much of the controlling software would need to be rewritten to control the new hardware system with the new component. Such rewriting is inefficient, from a time standpoint, and increases the cost (e.g., in money or person hours) of installing the new hardware component. In some cases, the computer programmer rewriting the code may have to travel to the geographic location where the hardware is installed. As a result, oftentimes, businesses that own or operate hardware structures controlled by software may forego modifying or updating the hardware structures. As the foregoing illustrates, a new approach for designing and maintaining hardware systems and software controlling the hardware systems may be desirable.

### SUMMARY

In some aspects, the disclosed subject matter relates to a system for interfacing with hardware components. The system can include a processing hardware unit. The system can include multiple first level hardware components, each first level hardware component being coupled with the processing hardware unit. The system can include multiple second level hardware components, each second level hardware component being coupled with at least one first level hardware component. The system can include a memory, accessible to the processing hardware unit. The memory can include a compiler for an object oriented programming language. The memory can include multiple first objects in the object oriented programming language. Each of the multiple first objects mirrors a first level hardware component. Each of the multiple first objects can include a representation of a feature of the first level hardware component and code for communicating with the first level hardware component. The memory can include multiple second objects in the object oriented programming language. Each of the multiple second objects mirrors a second level hardware component. Each of the multiple second objects can include a representation of a feature of the second level hardware component and code for communicating with the second level hardware component.

In some aspects, the disclosed subject matter relates to a non-transitory computer-readable storage medium. The computer-readable storage medium can include a compiler for an object oriented programming language. The computer-readable storage medium can include multiple first objects in the object oriented programming language. Each of the first objects mirrors a first level hardware component from among multiple first level hardware components. Each of the first objects can include a representation of a feature of the first level hardware component and code for communicating with the first level hardware component. The computer-readable storage medium can include multiple second objects in the object oriented programming language. Each of the second objects mirrors a second level hardware component from among multiple second level hardware components. Each of the second objects can include a representation of a feature of the second level hardware component and code for communicating with the second level hardware component. Each first level hardware component is coupled with a processing hardware unit, and each second level hardware component is coupled with at least one first level hardware component.

In some aspects, the disclosed subject matter relates to a computer-implemented method for interfacing with hardware. The method can include receiving, at a computing device, an instruction for controlling a hardware component of a light display. The instruction corresponds to an object in an object oriented scripting language. The object mirrors the hardware component of the light display. The method can include controlling, using the object, the hardware component of the light display according to the received instruction.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several aspects of the disclosed subject matter are set forth in the following figures.

FIG. 1A illustrates an example of a system of hardware components that may be interfaced with using object oriented programming.

FIG. 1B illustrates an example of a light emitting diode (LED) display system of hardware components that may be interfaced with using object oriented programming.

FIG. 1C illustrates an example of an energy generation system of hardware components that may be interfaced with using object oriented programming.

FIG. 2 illustrates an example of a computing device configured to interface with hardware components using object oriented programming.

FIG. 3 illustrates an example process for interfacing with a hardware component using object oriented programming.

FIG. 4 illustrates an example process for building and using a hardware system interfaced via object oriented programming.

FIG. 5A illustrates an example of a system for controlling a controlled structure via a remote computer.

FIG. 5B illustrates an example of a system for controlling a lighting structure via a remote computer.

FIG. 6 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

As set forth above, a new approach for designing and maintaining hardware systems controlled by software and software controlling the hardware systems may be desirable. The subject technology provides techniques for interfacing with hardware components using object oriented programming. According to some examples, each member of a set of hardware components in a system is associated with an object in an object oriented scripting language (e.g., JavaScript, Perl, or PHP: Hypertext Preprocessor (PHP)).

For instance, a light emitting diode (LED) display system, that can used in a stadium or on an outer wall of a building, may be controlled by high definition video signal (HDVS) processor(s). The HDVS processor(s) can be connected with fiber splitters that route traffic within the LED display system. The fiber splitters can be connected with matrix controllers, which manage a matrix of LED lamps in the LED display system. The matrix controllers can be connected with matrix blocks, which are responsible for lighting a single LED lamp block. The fiber splitters, matrix controllers, and matrix blocks are hardware components. Each of the fiber splitters, matrix controllers, and matrix blocks may be mirrored, in a memory of a computing device, with a fiber splitter object, a matrix controller object, or a matrix block object, respectively, in the object oriented scripting language.

Each object corresponding to a hardware component (e.g., each fiber splitter object, matrix controller object, or matrix block object) can include representation(s) of feature(s) (e.g., identifying features, manufacturing information, etc.) of the associated hardware component, representations of functionality (e.g., operational parameters or characteristics) of the associated hardware component and/or code for communicating with (e.g., sending information to or receiving information from) the associated hardware component.

Advantageously, some examples of the approaches described herein provide a representation of a mutable (rather than a static) configuration of the hardware system. As a result, a user, a technician, or any other person accessing the system may access current state information of the system via the object(s) mirroring the hardware component(s). As a result, some of the examples of the approaches described herein are an improvement over configuration file(s) or owner's manual(s) that are created at the time of manufacture and may not be modifiable after creation.

As used herein, the term “hardware” encompasses its plain and ordinary meaning including, but not limited to physical or tangible devices or mechanical, magnetic, electronic, or electrical devices in a system for performing a useful function. For example, in a LED display system, hardware can include, possibly among other things, fiber splitter(s), matrix controller(s), and matrix block(s). In an energy generating system, hardware can include, possibly among other things, power pipe(s), absorber tube(s), and power source block(s).

FIG. 1A illustrates an example of a system 100A of hardware components that may be interfaced with using object oriented programming.

As shown, the system 100A includes a processing hardware unit 102A, a computing device 104A, first level hardware components 110A, second level hardware components 120A, and third level hardware components 130A. While two first level hardware components 110A, three second level hardware components 120A, and four third level hardware components 130A are illustrated, the subject technology may be implemented with any number of first level hardware components 110A, second level hardware components 120A, or third level hardware components 130A.

The computing device 104A may include a compiler for an object oriented programming language and objects in the object oriented programming language mirroring the first level hardware components 110A, the second level hardware components 120A, and the third level hardware components 130A. The object oriented programming language can be a scripting language, for example, JavaScript, Perl, or PHP.

The processing hardware unit 102A is a processing hardware unit for controlling and communicating with the first level hardware components 110A, the second level hardware components 120A, and the third level hardware components 130A. For example, the first level hardware components 110A, the second level hardware components 120A, and the third level hardware components 130A can be components in a light emitting diode (LED) display system, and the processing hardware unit 102A can include high definition video signal (HDVS) processor(s). Alternatively, the processing hardware unit 102A can include processor(s) for controlling electronic equipment in a car (e.g., engine, transmission, fuel gauge, oil gauge, etc.), electronic equipment in an airplane, a municipal lighting system, a municipal public transit system, etc.

In some examples, the processing hardware unit 102A is distinct from the computing device 104A and communicates with the computing device 104A via a wired connection, a wireless connection, or a network connection. In some examples, the processing hardware unit 102A is a component of the computing device 104A (e.g., the central processing unit (CPU) of the computing device 104A) or the computing device 104A is a component of the processing hardware unit 102A.

As shown in FIG. 1A, the processing hardware unit 102A is configured (e.g., wired or wirelessly connected) to communicate directly with the first level hardware components 110A.1 and 110A.2. The second level hardware components 120A.1, 120A.2, and 120A.3 are accessible directly to an associated first level hardware component 110A.1 or 110A.2 and accessible to the processing hardware unit 102A through the associated first level hardware component 110A.1 or 110A.2. The third level hardware components 130A.1, 130A.2, 130A.3, and 130A.4 are accessible directly to an associated second level hardware component 120A.1, 120A.2, or 120A.3 and accessible to the processing hardware unit 102A through the associated second level hardware component 120A.1, 120A.2, or 120A.3. The first level hardware components 110A.1-2, the second level hardware components 120A.1-3, and the third level hardware components 130A.1-4 are interrelated with one anther and configured to communicate (e.g., exchange data) with one another. While three levels of hardware components 110A, 120A, and 130A are illustrated in FIG. 1A, the subject technology can be implemented with any number of levels of hardware components and any number of hardware components per level.

In some examples, the system 100A corresponds to a car. The first level hardware component 110A.1 corresponds to the engine and the first level hardware component 110A.2 corresponds to the transmission. One second level hardware component 120A.1 that is associated with the first level hardware component 110A.1 is the crankshaft. One second level hardware component 120A.2 that is associated with the first level hardware component 110A.1 is the cylinder. One second level hardware component 120A.3 that is associated with the first level hardware component 110A.2 is a gear selector of the transmission.

In some examples, the system 100A corresponds to a “smart house.” The first level hardware component 110A.1 is a kitchen node. The second level hardware component 120A.1, directly connected with the first level hardware component 110A.1, corresponds to a range stove. The third level hardware components 130A.1 and 130A.2, directly connected with the second level hardware component 120A.1 correspond to individual positions (e.g., for cooking pots or pans) on the range stove. The second level hardware component 120A.2, directly connected with the first level hardware component 110A.1, corresponds to a dishwasher. The third level hardware component 130A.3, directly connected with the second level hardware component 120A.2, corresponds to a dishwasher fluid store of the dishwasher. The first level hardware component 110A.2 is a living room node. The second level hardware component 120A.3, directly connected to the first level hardware component 110A.2, corresponds to a home entertainment system in the living room. The third level hardware component 130A.4, directly connected to the second level hardware component 120A.3, corresponds to a speaker of the home entertainment system.

The system 100A can correspond to any other hardware system that can be modeled using objects in an object oriented programming language. For example, the system 100A can be a heating, ventilation, and air conditioning (HVAC) system, and the hardware components 110A, 120A, or 130A can be components in the HVAC system. The system 100A can be a music playing system (e.g., a system in place at a concert hall, a symphony hall, an opera house, or a home stereo system), and the hardware components 110A, 120A, or 130A can be components in the music playing system. The system 100A can be a power plant, and the hardware components 110A, 120A, or 130A can be components in the power plant. The system 100A can be an electric grid, and the hardware components 110A, 120A, or 130A can be components in the electric grid.

FIG. 1B illustrates an example of light emitting diode (LED) display system 100B of hardware components that may be interfaced with using object oriented programming.

The LED display system 100B can correspond to an example implementation of the system 100A of FIG. 1A. As shown, the system 100B includes high definition video signal (HDVS) processor(s) 102B, a computing device 104B, fiber splitters 110B, matrix controllers 120B, and matrix blocks 130B. While two fiber splitters 110B, three matrix controllers 120B, and four matrix blocks 130B are illustrated, the subject technology may be implemented with any number of fiber splitters 110B, matrix controllers 120B, or matrix blocks 130B.

The LED display system 100B can be used, for example, in a stadium or on an outer wall of a building. The HDVS processor(s) 102B are processors (e.g., video processors) for controlling information displayed via the LED display system 100B and are configured to transmit data to or receive data from the fiber splitters 110B. The fiber splitters 110B route traffic within the LED display system 100B to matrix controller(s) 120B or matrix block(s) 130B connected to the fiber splitters 110B. The matrix controllers 120B control the lighting of one or more matrix blocks 130B connected to the matrix controllers 120B. Each matrix block 130B is responsible for lighting a single LED lamp block. Each matrix block 130B can include LEDs on a LED board. Each matrix controller 120B can include processor(s) for controlling LEDs on a LED board (e.g., LEDs of matrix block(s) 130B coupled to the matrix controller 120B). Hardware components of the LED display system 100B include the fiber splitters 110B, the matrix controllers 120B, and the matrix blocks 130B.

The computing device 104B may include a compiler for an object oriented programming language and objects in the object oriented programming language mirroring the fiber splitters 110B, the matrix controllers 120B, and the matrix blocks 130B. The object oriented programming language can be a scripting language, for example, JavaScript, Perl, or PHP.

In some examples, the HDVS processor(s) 102B are distinct from the computing device 104B and communicates with the computing device 104B via a wired connection, a wireless connection, or a network connection. In some examples, the HDVS processor(s) 102B are components of the computing device 104B (e.g., the central processing unit (CPU) of the computing device 104B) or the computing device 104B is a component of the HDVS processor(s) 102B.

As shown in FIG. 1B, the HDVS processor(s) 102B are configured (e.g., wired or wirelessly connected) to communicate directly with the fiber splitters 110B.1 and 110B.2. The matrix controllers 120B.1, 120B.2, and 120B.3 are accessible directly to an associated fiber splitter 110B.1 or 110B.2 and accessible to the HDVS processor(s) 102B through the associated fiber splitter 110B.1 or 110B.2. The matrix blocks 130B.1, 130B.2, 130B.3, and 130B.4 are accessible directly to an associated matrix controller 120B.1, 120B.2, or 120B.3 and accessible to the HDVS processor(s) 102B through the matrix controller 120B.1, 120B.2, or 120B.3. The fiber splitters 110B.1-2, the matrix controllers 1208.1-3, and the matrix blocks 130B.1-4 are interrelated with one anther and configured to communicate (e.g., exchange data) with one another. While three levels of hardware components 110B, 120B, and 130E are illustrated in FIG. 1B, the subject technology can be implemented with any number of levels of hardware components and any number of hardware components per level.

FIG. 1C illustrates an example of an energy generation system 100C of hardware components that may be interfaced with using object oriented programming.

The energy generation system 100C can correspond to a large scale energy generation system (e.g., a power plant for providing energy to multiple municipalities) or a small scale energy generation system (e.g., a personal solar generator installed in a residential house). The energy generation system 100 can be used in conjunction with a personal solar generator, a personal gasoline-based generator, a coal power plant, an oil power plant, a solar power plant, a hydroelectric power plant, etc.

As shown, the system 100C includes an energy generator controller 102C, a computing device 104C, power pipes 110C, absorber tubes 120C, and power source blocks 130C. While two power pipes 110C, three absorber tubes 120C, and power source blocks 130C are illustrated, the subject technology may be implemented with any number of power pipes 110C, absorber tubes 120C, or power source blocks 130C.

The energy generator controller 102C includes processor(s) for controlling energy generation via the system 100C and are configured to transmit data to or receive data from the power pipes 110C. The power pipes 110C route traffic within the energy generation system 100C to absorber tubes(s) 120C or power source block(s) 130C connected to the power pipes 110C. The absorber tubes 120C receive power from and control one or more power source blocks 130C connected to the absorber tubes 120C. Each power source block 130C is responsible for generating power from a power source (e.g., coal, oil, water in a dam, sun). The power generated at the power source block 130C is provided to an absorber tube 120C. The absorber tube 120C stores the generated power and provides the power to the power pipe 110C for transmission to a long-term power storage unit or to a power sink (e.g., a customer of a power supply company or an electrically powered device plugged into a wall plug of a house).

The computing device 104C may include a compiler for an object oriented programming language and objects in the object oriented programming language mirroring the power pipes 110C, the absorber tubes 120C, and the power source blocks 130C. The object oriented programming language can be a scripting language, for example, JavaScript, Perl, or PHP.

In some examples, the energy generator controller 102C is distinct from the computing device 104C and communicates with the computing device 104C via a wired connection, a wireless connection, or a network connection. In some examples, the energy generator controller 102C is a component of the computing device 104C (e.g., the central processing unit (CPU) of the computing device 104C) or the computing device 104C is a component of the energy generator controller 102C.

As shown in FIG. 1C, the energy generator controller 102C is configured (e.g., wired or wirelessly connected) to communicate directly with the power pipes 110C.1 and 110C.2. The absorber tubes 120C.1, 120C.2, and 120C.3 are accessible directly to an associated power pipe 110C.1 or 110C.2 and accessible to the energy generator controller 102C through the associated power pipe 110C.1 or 110C.2. The power source blocks 130C.1, 130C.2, 130C.3, and 130C.4 are accessible directly to an associated absorber tube 120C.1, 120C.2, or 120C.3 and accessible to the energy generator controller 102C through the absorber tube 120C.1, 120C.2, or 120C.3. The power pipes 110C.1-2, the absorber tubes 120C.1-3, and the power source blocks 130C.1-4 are interrelated with one anther and configured to communicate (e.g., exchange data) with one another. While three levels of hardware components 110C, 120C, and 130C are illustrated in FIG. 1C, the subject technology can be implemented with any number of levels of hardware components and any number of hardware components per level.

FIG. 2 illustrates an example of a computing device 200 configured to interface with hardware components using object oriented programming.

The computing device 200 can correspond to the computing device 104A of FIG. 1A, the computing device 104B of FIG. 1B, or the computing device 104C of FIG. 1C. The computing device 200 can include one or more of a server, a data repository, a single processor computing device, a multiprocessor computing device, a mobile phone, a personal digital assistant (PDA), a personal digital music player, a tablet computer, a laptop computer, a desktop computer, a television with one or more processors embedded therein or coupled thereto, etc.

As shown, the computing device 200 may include a central processing unit (CPU) 202, a network interface 204, a processing hardware unit interface 205, and a memory 206. The CPU 202 may include one or more processors. The CPU 202 is configured to execute computer instructions that are stored in a computer-readable storage medium, for example, the memory 206. The network interface 204 is configured to allow the computing device 200 to transmit and receive data in a network (e.g., the Internet, a wired network, a wireless local area network, or a wireless wide area network). The network interface 204 may include one or more network interface cards (NICs). The processing hardware unit interface 205 is configured to allow the computing device 200 to communicate with a processing hardware unit of a hardware system (e.g., processing hardware unit 102A of system 100A or HDVS processor(s) 102B of LED display system 100B). While the processing hardware unit interface 205 is illustrated as being separate and distinct from the network interface 204, in some examples, the processing hardware unit interface 205 can be the network interface 204 or a component of the network interface 204. While the processing hardware unit interface 205 is illustrated as being separate and distinct from the CPU 202, in some examples, the processing hardware unit interface 205 can be the CPU 202 or a component of CPU 202. In some examples, the CPU 202 functions as the processing hardware unit of the hardware system. The memory 206 stores data and/or instructions. As shown, the memory 206 includes a compiler 208, a hardware component control module 209, first level hardware component objects 210, second level hardware component objects 220, and third level hardware component objects 230.

The compiler 208 is a compiler for an object oriented programming language. The object oriented programming language can be an object oriented scripting language, for example, JavaScript, Perl, or PHP. The compiler 208 is configured to compile software code in the object oriented programming language (e.g., software code corresponding to the hardware component control module 209, the first level hardware component objects 210, the second level hardware component objects 220, or the third level hardware component objects 230) and prepare the software code for execution. According to some examples, the hardware component objects 210, 220, and 230 are implemented in JavaScript, and the compiler 208 corresponds to a Chrome V8 JavaScript Engine developed by Google Corporation of Mountain View, Calif.

In some examples, the computing device 200 is coupled with the hardware system 100A (e.g., the computing device 200 corresponds to the computing device 104A). The first level hardware component object 210.1 mirrors the first level hardware component 110A.1. For example, the first level hardware component object 210.1 includes representation(s) of feature(s) of the first level hardware component 110A.1 and code for communicating with the first level hardware component 110A.1. The code for communicating with the first level hardware component 110A.1 can include code for communicating with the first level hardware component 110A.1 via the processing hardware unit 102A. The feature(s) of the first level hardware component can include information identifying the first level hardware component (e.g., an identity number assigned to the component by the manufacturer), a component type of the first level hardware component (e.g., fiber splitter, speaker, subwoofer, pipe, engine, transmission, etc.), or a manufacturer of the first level hardware component. The remaining first level hardware component object 210.2, the second level hardware component objects 220.1-3, and the third level hardware component objects 230.1-4 similarly mirror, respectively, the remaining first level hardware component 110A.2, the second level hardware components 120A.1-3, and the third level hardware components 130A.1-4.

In similar fashion, the computing device 200 can be coupled with the LED display hardware system 100B, with the hardware component objects 210, 220, and 230 corresponding to the hardware components 110B, 120B, and 130B, respectively, of the LED display hardware system 100B. The computing device 200 can be coupled with the energy generation hardware system 100C, with the hardware component objects 210, 220, and 230 corresponding to the hardware components 110C, 120C, and 130C, respectively, of the energy generation hardware system 100C. The computing device 200 can be coupled with any hardware system that includes hardware components that can be represented as objects, not necessarily the systems 100A or 100B.

The hardware component objects 210.1-2, 220.1-3, and 230.1-4 are interrelated with one another (as are the physical hardware components (e.g., hardware components 110A.1-2, 120A.1-3, and 130A.1-4 or hardware components 110B.1-2, 120B.1-3, and 130B.1-4) to which the hardware component objects 210.1-2, 220.1-3, and 230.1-4 correspond). The hardware component objects 210.1-2, 220.1-3, and 230.1-4 may be configured to interact (e.g., exchange data) with one another. For example, the third level hardware component objects 230.1 and 230.2 may be sub-objects of second level hardware component object 220.1. In another example, data directed to the second level hardware component object 220.2 may need to be preprocessed by first level hardware component object 210.2 before being provided to the second level hardware component object 220.2.

As shown in FIG. 2, there are three levels of hardware component objects 210, 220, and 220, with two objects 210.1-2 at the first level, three objects 220.1-3 at the second level, and four objects 230.1-4 at the third level. However, the computing device 200 can be implemented with any number of levels and any number of objects per level (as the systems 100A and 100B can be implemented with any number of levels and any number of hardware components per level).

As shown, the memory 206 also includes the hardware component control module 209. The hardware component control module 209 is configured to receive an instruction for controlling a hardware component that is mirrored by one of the hardware component objects 210, 220, or 230. The hardware component control module is configured to control, using the hardware component object 210, 220, or 230 that mirrors the hardware component in the received instruction, the hardware component according to the received instruction. The instruction can be received from a user of the computing device 200 via an input/output element (e.g., a keyboard, a mouse, or a touch screen) of the computing device 200. The instruction can be received remotely over the network using the network interface 204. The instruction can correspond to software code within the hardware component object 210, 220, or 230 or to software code that executes in conjunction with the hardware component object 210, 220, or 230. Controlling the hardware component can include receiving information (e.g., features or current state information) of the hardware component or changing current state information of the hardware component. For example, color(s) of pixel(s) in the hardware component can be changed or provided to the computing device 200. In other examples, a volume of audio from the hardware component can be changed or provided to the computing device 200, a temperature of the hardware component (e.g., oven) can be changed or provided to the computing device 200, an operating speed (e.g., revolutions per minute) of the hardware component (e.g., engine controlling revolving component, e.g., wheel) can be changed or provided to the computing device 200.

According to some examples, all or a portion of the components 208, 209, 210, 220, or 230 of the memory 206 may be modifiable by a user of the computing device 200 accessing input/output element(s) of the computing device or by a remote user or computer program connecting to the computing device 200 using a remote computer that communicates with the computing device 200 over a network accessible using the network interface 204.

FIG. 3 illustrates an example process 300 for interfacing with a hardware component using object oriented programming.

The process 300 begins at step 310, where a computing device (e.g., computing device 200 via operation of the hardware component control module 209) receives an instruction for controlling a hardware component of a light display (e.g., one of the hardware components 110B, 120B, or 130B). The instruction corresponds to an object in an object oriented scripting language (e.g., one of the objects 210, 220, or 230). The object mirrors the hardware component in the light display. The received instruction can be associated with code that executes within the object (e.g., a function or procedure within the object). Alternatively, the received instruction can be associated with code that executes in conjunction with the object (e.g., a function or procedure that accesses the object but is not within the object).

In step 320, the computing device controls, using the object, the hardware component of the light display according to the received instruction. Controlling the hardware component of the light display can include accessing features of the hardware component, accessing state information of the hardware component, or modifying state information of the hardware component. Features of the hardware component can include immutable features of the hardware component that are set at the time of manufacture (e.g., a manufacturer's identification number for the hardware component, an identity of the manufacturer, a radio frequency at which the hardware component transmits or receives data, etc.). State information of the hardware component can include mutable state information of the hardware component (e.g., a color of a pixel, whether the pixel is turned on or off, a remaining battery life of a battery, etc.).

Optionally, in step 330, the computing device mirrors, in the object, modifications of the hardware component responsive to the received instruction. In other words, the software (e.g., the object in the object oriented scripting language) can mirror the hardware (e.g., the hardware component). For example, if the hardware component is a matrix block that, responsive to the received instruction, changed its color from red to green, a data structure in the object for storing the color of the matrix block can be updated from red to green. After step 330, the process 300 ends.

FIG. 4 illustrates an example process 400 for building and using a hardware system interfaced via object oriented programming.

The process 400 begins at step 410, where engineer(s) build a hardware system according to a specification provided by a customer. The hardware system can include multiple hardware components. For example, the hardware system can be a LED display system including multiple fiber splitters, matrix controllers, and matrix blocks. The hardware system can be a car including the hardware of an engine, a transmission, and associated parts of an engine and transmission. The hardware system can be a “smart house” with the hardware of a kitchen that can include a range stove, an oven, a microwave, and a dishwasher, a living room that can include a television and a home entertainment system, and a storage room that can include a washer, a dryer, and an electrical closet, an electrical wiring system, and a plumbing system. The hardware system can be a heating, ventilation, and air conditioning (HVAC) system for one or more buildings or a part of a building. The hardware system can be a power plant.

In step 420, the engineer(s) (or other or additional engineer(s)) mirror the multiple hardware components of the hardware system in interrelated software objects. Each of the interrelated software objects is uniquely associated with a hardware component of the hardware system. The objects can be written in an object oriented programming language, for example, an object oriented scripting language. Object oriented scripting languages include JavaScript, Perl, and PHP.

For example, in the LED display system, objects can correspond to the fiber splitters, matrix controllers, and matrix blocks. In the car, objects can correspond to the engine, the transmission, and the parts of the engine and the transmission. In the “smart house,” objects can correspond to the kitchen, the range stove, the oven, the microwave, the dishwasher, the living room, the television, the home entertainment system and its component parts, the storage room, the washer, the dryer, the electrical closet, the electrical wiring system, and the plumbing system.

In step 430, a computing device uses the interrelated software object(s) to control the associated hardware component(s) or access features of the associated hardware component(s). After step 430, the process 400 ends.

FIG. 5A illustrates an example of a system 500A for controlling a controlled structure via a remote computer.

As shown, the system 500A includes a remote computer 510A, a network 520A, a computing device 530A, and a controlled structure 540A.

The remote computer 510A can be, for example, a mobile phone, a personal digital assistant (PDA), a personal digital music player, a tablet computer, a laptop computer, a desktop computer, a television with one or more processors embedded therein or coupled thereto, etc. The remote computer can be an end-user device that is used by an end-user, for example, a smart device. The remote computer 510A can include one or more applications that include code for accessing the network 520A and controlling the controlled structure 540A via the network. While an example of the subject technology is illustrated in FIG. 5A in conjunction with a single remote computer 510A, the subject technology can be implemented in conjunction with multiple remote computers 510A, each of which can be used to remotely access and control the controlled structure 540A.

The network 520A can include, for example, one or more of the Internet, an intranet, a virtual private network (VPN), a wired network, a wireless wide area network (WWAN), or a wireless local area network (WLAN).

The computing device 530A is configured to control the controlled structure 540B. The computing device 530A can correspond to the computing device 104A of FIG. 1A and can include structures similar to the computing device 200 of FIG. 2. The computing device 530B can include objects in an object oriented programming language mirroring hardware components of the controlled structure 540A. In some examples, the computing device 530B corresponds to the computing device 104B of FIG. 1B or to the computing device 104C of FIG. 1C. The computing device 530A can control the controlled structure 540A by receiving instructions, over the network 520A (e.g., from the remote computer 510A), for controlling the controlled structure 540A and controlling the controlled structure 540A according to the received instructions. Alternatively, the computing device 530A can receive the instructions via input/output elements of the computing device 530A. For example, a user can input instructions directly to the computing device 530A via the keyboard, mouse, or touch screen of the computing device 530A. Upon executing an instruction that modifies a hardware component of the controlled structure 540A, a corresponding object in the object oriented programming language mirroring the hardware component in the memory of the computing device 530A is also modified.

The controlled structure 540A can include any hardware structure. For example, the controlled structure 540A can correspond to a lighting structure (e.g., a LED display structure) or an energy generation structure (e.g., a power plant or a personal home energy generator). In some examples, the controlled structure 540A corresponds to an energy grid (e.g., in a municipality), a vehicle, a “smart house,” etc. Using the system 500A, the energy grid, vehicle, or “smart house” can be controlled remotely and problems with the energy grid, vehicle, or “smart house” can be diagnosed or repaired remotely. For example, if a driver is having problems with his/her car, the driver can telephone the dealership, and a technician at the dealership can diagnose or repair the problem remotely using a remote computer 510A. Advantageously, the driver may not need to visit the dealership to have his/her car repaired.

Advantageously, as a result some implementations of the system of FIG. 5A, the controlled structure 540A can be controlled and maintenance and repair of the controlled structure 540A can be performed remotely. For example, the controlled structure 540A can be installed in a solar power plant in a remote rural area in Arizona. If a problem occurs with the solar power plant during a key time when many people are depending on the solar power plant for energy, a technician based in Philadelphia, Pa. can be notified, and the technician can diagnose or fix the problem (e.g., by modifying the code of the objects in the object oriented programming language or executing script(s) in the object oriented programming language) remotely using the remote computer 510A (which can be, for example, the technician's mobile phone, tablet computer, or laptop computer). Due to the implementation described in FIG. 5A, the technician may be able to quickly begin fixing the problem using his/her smart phone and the technician does not need to travel to Arizona to fix the problem.

In some examples, the controlled structure 540A corresponds to a smart traffic control system (e.g., for vehicular traffic in all or part of a city) including traffic lights and adjustable speed limit or road closure signs. The remote computer 510A can be a smart phone of a police chief, a city mayor, or another person responsible for traffic control. Upon learning that a car accident occurred at a particular location or detecting an unusual traffic pattern, the police chief can quickly use his/her smart phone to reduce or change speed limit(s), close road(s), increase or change yellow or red light time(s), etc., to more effectively respond to the accident. The police chief can make these changes from any location where he/she has access to his/her smartphone (e.g., at the scene of the accident, in his/her office, or remotely from a vacation destination). In addition, upon learning that a traffic light or traffic sign is not functioning correctly, a technician having access to the remote computer 510A can attempt to diagnose the problem or repair the traffic light or traffic sign.

FIG. 5B illustrates an example of a system 500B for controlling a lighting structure via a remote computer.

As shown, the system 500B includes a remote computer 510B, a network 520B, a computing device 530B, and a lighting structure 540B.

The remote computer 510B can be, for example, a mobile phone, a personal digital assistant (PDA), a personal digital music player, a tablet computer, a laptop computer, a desktop computer, a television with one or more processors embedded therein or coupled thereto, etc. The remote computer can be an end-user device that is used by an end-user, for example, a smart device. The remote computer 510B can include one or more applications that include code for accessing the network 520B and controlling the lighting structure 540B via the network. While an example of the subject technology is illustrated in FIG. 5B in conjunction with a single remote computer 510B, the subject technology can be implemented in conjunction with multiple remote computers 510B, each of which can be used to remotely access and control the lighting structure 540B.

The network 520B can include, for example, one or more of the Internet, an intranet, a virtual private network (VPN), a wired network, a wireless wide area network (WWAN), or a wireless local area network (WLAN).

The computing device 530B is configured to control the lighting structure 540B. The computing device 530B can correspond to the computing device 104B of FIG. 1B and can include structures similar to the computing device 200 of FIG. 2. The computing device 530B can include objects in an object oriented programming language mirroring hardware components of the lighting structure 540B. In some examples, the computing device 530B corresponds to the computing device 104A of FIG. 1A. The computing device 530B can control the lighting structure 540B by receiving instructions, over the network 520B (e.g., from the remote computer 510B), for controlling the lighting structure 540B and controlling the lighting structure 540B according to the received instructions. Alternatively, the computing device 530B can receive the instructions via input/output elements of the computing device 530B. For example, a user can input instructions directly to the computing device 530B via the keyboard, mouse, or touch screen of the computing device 530B. Upon executing an instruction that modifies a hardware component of the lighting structure 540B, a corresponding object in the object oriented programming language mirroring the hardware component in the memory of the computing device 530B is also modified.

The lighting structure 540B can include one or more LED display screens that can be placed, for example, in a stadium or on an outer wall of a building. In some aspects, the lighting structure 540B corresponds to the HDVS processor(s) 102B, the fiber splitters 110B, the matrix controllers 120B, and the matrix blocks 130B of FIG. 1B.

Advantageously, as a result some implementations of the system of FIG. 5B, the lighting structure 540B can be controlled and maintenance and repair of the lighting structure 540B can be performed remotely. For example, the lighting structure 540B can be installed in an entertainment arena in Boston, Mass. If a problem occurs with the lighting structure during a key time (e.g., during an event at the entertainment arena where information is presented via the lighting structure 540B), a technician based in Los Angeles, Calif. can be notified, and the technician can diagnose or fix the problem (e.g., by modifying the code of the objects in the object oriented programming language or executing script(s) in the object oriented programming language) remotely using the remote computer 510B (which can be, for example, the technician's mobile phone, tablet computer, or laptop computer). Due to the implementation described in FIG. 5B, the technician may be able to quickly begin fixing the problem using his/her smart phone and the technician does not need to travel to Boston to fix the problem.

While FIG. 5B is described in conjunction with the lighting structure 540B, any hardware system can replace the lighting structure 540B, for example, as illustrated in FIG. 5A.

According to some implementations, a hardware component can be represented by a generic “abstract” component software object. A representation (e.g., in software) of a specific hardware component can be derived from the generic “abstract” component software object.

For example, a matrix block can correspond to a “generic” software component called “MB.” Different versions of hardware components have different properties. However, similar types of components possess similar functionality. Hence this similar functionality can be abstracted and implemented in the MB component and then custom hardware-version-specific functionality can be implemented in different types of matrix blocks. For example, a hardware of matrix block 16 v1 can correspond to a software object MB16v1. A hardware of matrix block 16 v2 can correspond to a software object MB16v2. A hardware of matrix block 24 v1 can correspond to a software object MB24v1. A hardware of matrix block 32 v1 can correspond to a software object MB32v1, etc. All of the software objects MB16v1, MB16v2, MB24v1, MB24v2, MB32v1, etc., inherit and/or derive from the software object MB. In some cases, changing properties of a parent object (e.g., MB) can also change the properties of objects inheriting or deriving from the parent (e.g., MB16v1, MB16v2, MB24v1, MB24v2, MB32v1, etc.).

In some examples, a LED board contains multiple types of matrix blocks. To send a command to all matrix blocks, the system may enumerate all matrix block components and then send a command to them. This functionality can be generic and independent of types of matrix block components currently installed in the infrastructure. Thus, all matrix block software objects can be enumerated by their “type,” which can be, for example, “generic component.” Once all of the components have been enumerated, each component can be treated as a generic software object (e.g., a generic “MB” software object), controlling generic functionality. Alternatively, the specific type of the software object (e.g., “MB16v1” software object) can be determined, and the specific functionality of the specific type of the software object can be accessed.

FIG. 6 conceptually illustrates an electronic system 600 with which some implementations of the subject technology are implemented. For example, one or more of the computing device 104A, the computing device 104B, the computing device 104C, the computing device 200, the remote computer 510A, the computing device 530A, the remote computer 510B, or the computing device 530B may be implemented using the arrangement of the electronic system 600. The electronic system 600 can be a computer (e.g., a mobile phone, PDA), or any other sort of electronic device. Such an electronic system includes various types of computer readable media and interfaces for various other types of computer readable media. Electronic system 600 includes a bus 605, processing unit(s) 610, a system memory 615, a read-only memory 620, a permanent storage device 625, an input device interface 630, an output device interface 635, and a network interface 640.

The bus 605 collectively represents all system, peripheral, and chipset buses that communicatively connect the numerous internal devices of the electronic system 600. For instance, the bus 605 communicatively connects the processing unit(s) 610 with the read-only memory 620, the system memory 615, and the permanent storage device 625.

From these various memory units, the processing unit(s) 610 retrieves instructions to execute and data to process in order to execute the processes of the subject technology. The processing unit(s) can be a single processor or a multi-core processor in different implementations.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some implementations of the subject technology use a mass-storage device (for example a magnetic or optical disk and its corresponding disk drive) as the permanent storage device 625.

Other implementations use a removable storage device (for example a floppy disk, flash drive, and its corresponding disk drive) as the permanent storage device 625. Like the permanent storage device 625, the system memory 615 is a read-and-write memory device. However, unlike storage device 625, the system memory 615 is a volatile read-and-write memory, such a random access memory. The system memory 615 stores some of the instructions and data that the processor needs at runtime. In some implementations, the processes of the subject technology are stored in the system memory 615, the permanent storage device 625, or the read-only memory 620. For example, the various memory units include instructions for interfacing with hardware components using object oriented programming in accordance with some implementations. From these various memory units, the processing unit(s) 610 retrieves instructions to execute and data to process in order to execute the processes of some implementations.

The bus 605 also connects to the input and output device interfaces 630 and 635. The input device interface 630 enables the user to communicate information and select commands to the electronic system. Input devices used with input device interface 630 include, for example, alphanumeric keyboards and pointing devices (also called “cursor control devices”). Output device interfaces 635 enables, for example, the display of images generated by the electronic system 600. Output devices used with output device interface 635 include, for example, printers and display devices, for example cathode ray tubes (CRT) or liquid crystal displays (LCD). Some implementations include devices for example a touch screen that functions as both input and output devices.

Finally, as shown in FIG. 6, bus 605 also couples electronic system 600 to a network (not shown) through a network interface 640. In this manner, the electronic system 600 can be a part of a network of computers (for example a local area network (“LAN”), a wide area network (“WAN”), or an Intranet, or a network of networks, for example the Internet. Any or all components of electronic system 600 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A system for interfacing with hardware components, the system comprising:
a processing hardware unit;
a plurality of first level hardware components, each first level hardware component being coupled with the processing hardware unit;
a plurality of second level hardware components, each second level hardware component being coupled with at least one first level hardware component; and
a memory, accessible to the processing hardware unit, the memory comprising:
a compiler for an object oriented programming language;
a first plurality of objects in the object oriented programming language, each of the first plurality of objects mirroring a first level hardware component, each of the first plurality of objects comprising a representation of a feature or a functionality of the first level hardware component and code for communicating with the first level hardware component; and
a second plurality of objects in the object oriented programming language, each of the second plurality of objects mirroring a second level hardware component, each of the second plurality of objects comprising a representation of a feature or a functionality of the second level hardware component and code for communicating with the second level hardware component.

2. The system of claim 1, wherein the object oriented programming language comprises a scripting language.

3. The system of claim 1, further comprising:
a plurality of third level hardware components, each third level hardware component being coupled with at least one second level hardware component,
wherein the memory further comprises:
a third plurality of objects in the object oriented programming language, each of the third plurality of objects mirroring a third level hardware component, each of the third plurality of objects comprising a representation of a feature or a functionality of the third level hardware component and code for communicating with the third level hardware component.

4. The system of claim 3, wherein the processing hardware unit comprises a video processor, wherein the plurality of first level hardware components comprise fiber splitters, wherein the plurality of second level hardware components comprise matrix controllers, and wherein the plurality of third level hardware components comprise matrix blocks.

5. The system of claim 4, wherein the matrix blocks comprise light emitting diodes (LEDs) on a light emitting diode (LED) board.

6. The system of claim 4, wherein the matrix controllers comprise processors for controlling light emitting diodes (LEDs) on a light emitting diode (LED) board.

7. The system of claim 1, wherein the feature or a functionality of the first level hardware component comprises one or more of information identifying the first level hardware component, a component type of the first level hardware component, a manufacturer of the first level hardware component, an operational parameter of the hardware component, or a characteristic of the hardware component.

8. The system of claim 1, wherein the processing hardware unit and the memory reside within a computing device, and wherein the plurality of first level hardware components and the plurality of second level hardware components reside externally to the computing device.

9. The system of claim 1, wherein the memory is modifiable via a remote computing device accessing the memory via a network.

10. The system of claim 1, wherein the plurality of first level hardware components and the plurality of second level hardware components comprise components in a heating, ventilation, and air conditioning (HVAC) system.

11. The system of claim 1, wherein the plurality of first level hardware components and the plurality of second level hardware components comprise components in a music playing system.

12. The system of claim 1, wherein the plurality of first level hardware components and the plurality of second level hardware components comprise components in a power plant.

13. A non-transitory computer-readable storage medium for interfacing with hardware, the non-transitory computer-readable medium comprising:
a compiler for an object oriented programming language;
a first plurality of objects in the object oriented programming language, each of the first plurality of objects mirroring a first level hardware component from among a plurality of first level hardware components, each of the first plurality of objects comprising a representation of a feature or a functionality of the first level hardware component and code for communicating with the first level hardware component; and
a second plurality of objects in the object oriented programming language, each of the second plurality of objects mirroring a second level hardware component from among a plurality of second level hardware components, each of the second plurality of objects comprising a representation of a feature or a functionality of the second level hardware component and code for communicating with the second level hardware component,
wherein each first level hardware component is coupled with a processing hardware unit, and wherein each second level hardware component is coupled with at least one first level hardware component.

14. The computer-readable medium of claim 13, wherein the object oriented programming language comprises a scripting language.

15. The computer-readable medium of claim 13, further comprising:
a third plurality of objects in the object oriented programming language, each of the third plurality of objects mirroring a third level hardware component from among a plurality of third level hardware components, each of the third plurality of objects comprising a representation of a feature or a functionality of the third level hardware component and code for communicating with the third level hardware component, wherein each third level hardware component is coupled with at least one second level hardware component

16. The computer-readable medium of claim 15, wherein the processing hardware unit comprises a video processor, wherein the plurality of first level hardware components comprise fiber splitters, wherein the plurality of second level hardware components comprise matrix controllers, and wherein the plurality of third level hardware components comprise matrix blocks.

17. The computer-readable medium of claim 16, wherein the matrix blocks comprise light emitting diodes (LEDs) on a light emitting diode (LED) board.

18. The computer-readable medium of claim 16, wherein the matrix controllers comprise processors for controlling light emitting diodes (LEDs) on a light emitting diode (LED) board.

19. The computer-readable medium of claim 13, wherein the feature or a functionality of the first level hardware component comprises one or more of information identifying the first level hardware component, a component type of the first level hardware component, a manufacturer of the first level hardware component, an operational parameter of the hardware component, or a characteristic of the hardware component.

20. The computer-readable medium of claim 13, wherein the processing hardware unit and the computer-readable medium reside within a computing device, and wherein the plurality of first level hardware components and the plurality of second level hardware components reside externally to the computing device.

21. The computer-readable medium of claim 13, wherein the computer-readable medium is modifiable via a remote computing device accessing the computer-readable medium via a network.

22. The computer-readable medium of claim 13, wherein the plurality of first level hardware components and the plurality of second level hardware components comprise components in a heating, ventilation, and air conditioning (HVAC) system.

23. The computer-readable medium of claim 13, wherein the plurality of first level hardware components and the plurality of second level hardware components comprise components in a music playing system.

24. The computer-readable medium of claim 13, wherein the plurality of first level hardware components and the plurality of second level hardware components comprise components in a power plant.

25. A method for interfacing with hardware, the method comprising:
receiving, at a computing device, an instruction for controlling a hardware component of a light display, the instruction corresponding to an object in an object oriented scripting language, wherein the object mirrors the hardware component of the light display;
controlling, using the object, the hardware component of the light display according to the received instruction.

26. The method of claim 25, further comprising:
mirroring, in the object, modifications of the hardware component responsive to the received instructions.

27. The method of claim 25, wherein the received instruction is associated with code executing in conjunction with the object.

28. The method of claim 25, wherein the received instruction is associated with code executing within the object.
